(19) United States
(12) Patent Application Publication
(10) Pub. No.: US 2012/0239971 A1
(43) Pub. Date: Sep. 20, 2012

(54) MITIGATING KNOWN SOFTWARE DEFECTS

(75) Inventors: PAUL FRANKLIN MCMAHAN, Apex, NC (US); DOUGLAS BRIAN MUELLER, Apex, NC (US)

(73) Assignee: International Business Machines Corporation, Armonk, NY (US)

(21) Appl. No.: 13/048,244

(22) Filed: Mar. 15, 2011

(51) Int. Cl. G06F 11/14

(52) U.S. Cl. 714/15; 714/E11.117

(57) ABSTRACT

A method, system, and computer program product for mitigating known software defects are provided in the illustrative embodiments. A code containing the defect is executed in a data processing system. An error caused by the defect is detected. A function implemented external to the code is called, where the function is a part of a library accessible to the code, and where the function is called for the code for a purpose other than to correct the error. A corrective code embedded in the function is executed, the corrective code attempting to correct the error. Executing the code is continued after the corrective code has corrected the error.

### BACKGROUND

1. Technical Field

The present invention relates generally to a computer implemented method, system, and computer program product for executing a software application in a data processing environment. More particularly, the present invention relates to a computer implemented method, system, and computer program product for mitigating known software defects in the software application during the execution in the data processing environment.

2. Description of the Related Art

A software application (application) is code that is configured to perform certain operations when executed in a data processing system. Modern applications often include thousands, if not millions, of lines of code, which perform numerous operations of varying degrees of complexity when executed in a data processing system.

Designing such complex and extensive applications invariably includes the hazards of design errors, coding errors, unforeseen erroneous consequences of a design, and many other defects that impart undesirable behavior to the application. Generally, many errors and error causing design or code defects are detected and corrected during the testing phase of application design. Some defects may, however, escape detection until very late in the testing cycle or even after the application has been released and deployed on data processing systems.

Correcting a defect in an application after a certain point in the testing cycle is not always possible or feasible. For example, as a policy, the application's code may be frozen from further changes even if defects are detected in the code because the cost of modifying the code and retesting may be prohibitive. Another reason for not changing the code beyond a certain point in the testing may be that the error caused by the defect may not be significant enough to warrant a change at the increased cost and risk of introducing new errors by way of the code changes.

It is often difficult to accurately assess whether a known error or defect in the application warrants a code change. When an error is detected or a defect is found during this final phase, it can be difficult to decide whether the risk and effort to change the source code are justified. Two important factors in making that decision are—how likely would it be for an end user of the software to encounter the defect, and what is the impact of encountering the defect. When these two factors are underestimated the application may be delivered without correcting the defect, leading to expensive maintenance and user dissatisfaction. Conversely, when these two factors are overestimated, the defect may be corrected before delivery but the risk and effort of that correction could have been avoided.

### SUMMARY

The illustrative embodiments provide a method, system, and computer program product for mitigating known software defects. An embodiment executes a code containing the defect in a data processing system. The embodiment detects an error caused by the defect. The embodiment calls a function implemented external to the code, wherein the function is a part of a library accessible to the code, and wherein the function is called for the code for a purpose other than to correct the error. The embodiment executes a corrective code embedded in the function, the corrective code attempting to correct the error. The embodiment continues executing the code after the corrective code has corrected the error.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a configuration for mitigating known software defects in accordance with an illustrative embodiment;

FIG. 4 depicts an example code of an application in which a known defect has been mitigated without modifying the code, in accordance with an illustrative embodiment;

FIG. 5 depicts a flowchart of an example process of configuring software code for mitigating known software defects in accordance with an illustrative embodiment; and

FIG. 6 depicts a flowchart of another example process of mitigating known software errors in accordance with an illustrative embodiment.

### DETAILED DESCRIPTION

As hardware and software grows increasingly complex, autonomic systems are being conceptualized to automate many of the functions associated with computing. Autonomic systems are systems, whether hardware or software, that know themselves and their components. An autonomic system should be able to reconfigure itself depending on the circumstances, self optimize its operations, self-heal from certain events or malfunctions, self-protect, and act according to the environment and the context surrounding its activities. An autonomic system should be able to function in a heterogeneous world of computing resources and should use open standards. An autonomic system should be able to do all this and be able to optimize its resource needs without exposing its complexity.

Self-healing is an important aspect of autonomic systems of the future as well as a very desirable feature in present day systems. The invention recognizes that the existing software applications that include some notion of self-healing suffer from certain disadvantages. As an example of the disadvantages, when an application encounters an error, the error recovery usually relies on something external to the application's thread, such as another application executing as a different process, to detect the error and take any corrective action. External applications often do not have access to the detailed state of the application where the error occurs and respond to the error based on very limited exception data that is made available from the application encountering the error.

As another example of the disadvantages, certain applications that are configured to correct their own errors include code within the applications' logic to detect and correct the error. This approach requires application code to be engineered with error recovery code, which also has to be quality-tested, and has the potential of introducing new errors of its own. The application code has to be modified for each new discovered defect, leading to the increased costs and risks as described earlier. Furthermore, the application code has to be modified again to remove the error correction code when the root cause of the defect is rectified.

The illustrative embodiments used to describe the invention generally address and solve the above-described problems and other problems related to managing software defects. The illustrative embodiments provide a method, system, and computer program product for mitigating known software defects. The illustrative embodiments describe aspects of a non-intrusive mechanism to reduce the potential impact of a known software defect without changing the underlying source code of the application.

Using an illustrative embodiment, the application code remains unchanged and executes in the exact same manner as tested, i.e. the known defect is not corrected in the application's code. The illustrative embodiments describe example ways of including a dormant corrective mechanism in the software that includes the application code, which can be activated on demand. For example, the corrective mechanism may be activated when the likelihood or impact of encountering the defect in the production environment was underestimated during testing and release.

The corrective mechanism is implemented as a part of a library that is called from the application by using the library's published application programming interfaces (APIs). Generally, the library is external to the code of the application, and is often provided as third-party tools that are incorporated into the application's code.

Furthermore, the nature of such external/third-party library according to an embodiment is such that calls to at least some of the library's APIs occur in a location of the source code where the defect may exist. Only as an example, and without intending or implying any limitation on the invention, some illustrative embodiments are described herein with respect to a logging tool or logger library, which provides logging functionality to an application code.

Frequent calls to logger APIs are common in well written codes. An illustrative embodiment can be implemented as a modified code of a published logger API such that when that logger API is called from an area of the application's code where the defect lies, the modified code of the logger API can take the corrective action on behalf of the application.

Such a modified logging library (mitigating log handler) may be implemented in a code module that is installed with the application but is not activated by default. The modified library code can be activated without manipulating the code of the application or the library, such as by simply adjusting the logging configuration for the application.

Other libraries can be modified and used in conjunction with an illustrative embodiment in a similar manner. For example, application code often includes instrumentation for performance measurement and tuning. The performance measurement and tuning functions are generally included in the code by calling APIs of a third-party provided performance instrumentation library. The code of an API in the performance instrumentation library can be modified and activated in an illustrative embodiment, in a manner similar to the logger library described above.

The illustrative embodiments are described with respect to certain data, data structures, file-systems, file names, directories, and paths only as examples. Such descriptions are not intended to be limiting on the invention. For example, an illustrative embodiment described with respect to a local application name and path can be implemented as an application on a remote path within the scope of the invention.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are further described with respect to certain applications only as examples. Such descriptions are not intended to be limiting on the invention. An embodiment of the invention may be implemented with respect to any type of application, such as, for example, applications that are served, the instances of any type of server application, a platform application, a stand-alone application, an administration application, or a combination thereof.

An application may further include data objects, code objects, encapsulated instructions, application fragments, services, and other types of resources available in a data processing environment. For example, a Java® object, an Enterprise Java Bean (EJB), a servlet, or an applet may be manifestations of an application with respect to which the invention may be implemented. (Java and all Java-based trademarks and logos are trademarks or registered trademarks of Oracle and/or its affiliates).

The illustrative embodiments are described using specific code, designs, architectures, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

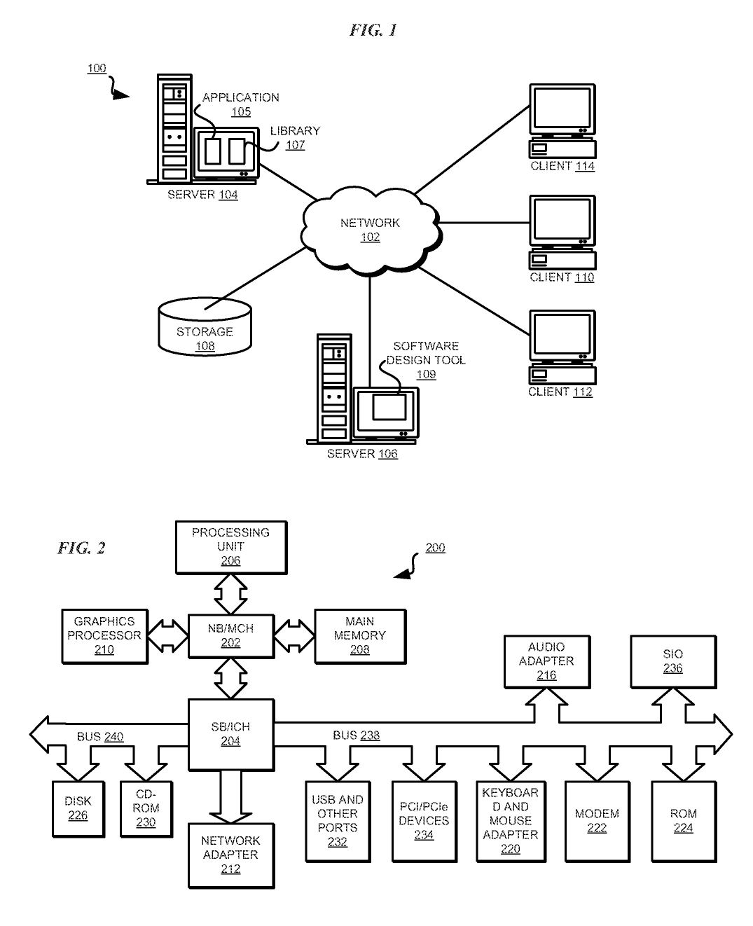

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Any data processing system, such as server 104, may include application 105 according to an embodiment. Application 105 may be constructed and used as described in this disclosure. Any data processing system, such as server 104, may also include library 107. Library 107 may be a suitable library of functionality accessible to application 105 and modifiable in accordance with an illustrative embodiment. Server 106 may include software design tool 109. Software design tool 109 may be any tool, application, service, or methodology implementation for designing, coding, engineering, architecting, or otherwise creating software applications, such as application 105.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may collaborate as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes of the illustrative embodiments may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCl/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle and/or its affiliates).

Program instructions for the operating system, the object-oriented programming system, the processes of the illustrative embodiments, and applications or programs are located on storage devices, such as hard disk drive 226, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

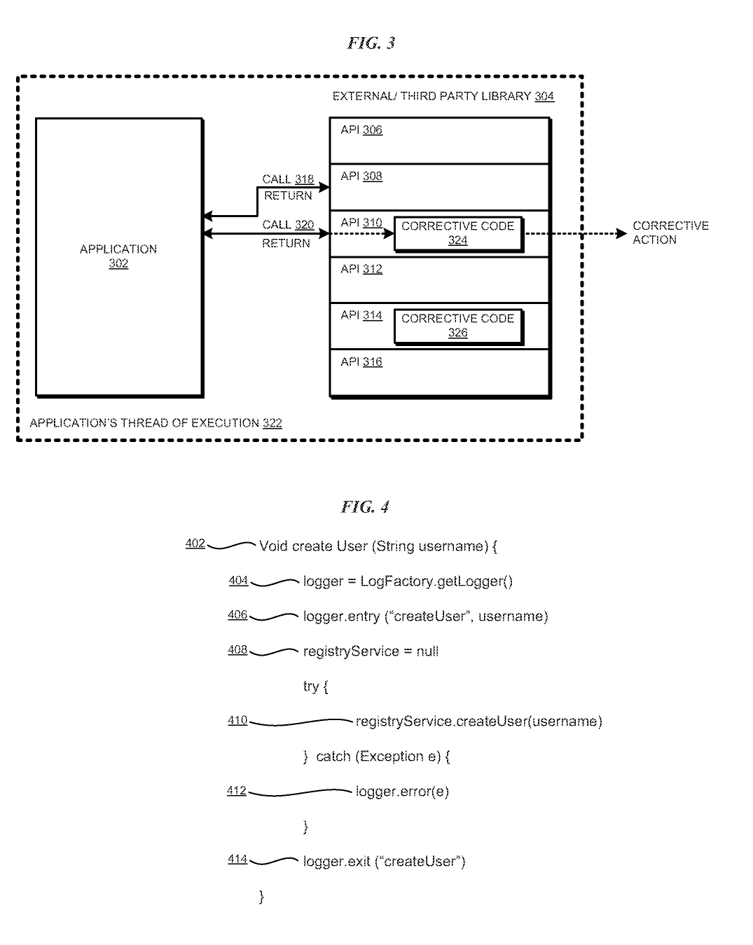

With reference to FIG. 3, this figure depicts a block diagram of a configuration for mitigating known software defects in accordance with an illustrative embodiment. Application 302 may be analogous to application 105 in FIG. 1, and may be designed, coded, or engineered using any suitable software design process, application, tool, or methodology, such as software design tool 109 in FIG. 1. Library 304 may be a library of published APIs utilized by application 302. Library 304 may be external to the application 302′s code, and may or may not be provided by a third-party vendor.

Library 304 includes a set of APIs, such as APIs 306, 308, 310, 312, 314, and 316. A set of APIs is one or more API. Calls 318 and 320 to library 304's APIs are handled within application 302's thread of execution 322.

As an example of the operation of the illustrative embodiment, code of application 302 makes call 318 to API 308 of library 304. For example, if library 304 is a logger library, call 318 may write to a log file certain state variables, such as the values of certain environment variables at a certain point in the execution of application 302.

Application 302 may return from call 318, continue operation, and make call 320 to API 310. In accordance with an illustrative embodiment, the code of API 310 has been modified to include corrective code 324. Assume that API 310 is such an API that is called when application 302 raises an exception, encounters an error, or malfunctions in another manner, due to a defect present in the code of application 302.

When API 310 is called, corrective code 324 attempts to take a corrective action on behalf of application 302 to recover from the error caused by the defect. Application 302 continues operation upon returning from call 320 such that the error caused by the defect in the code of application 302 is corrected by corrective code 324 in library 304.

API 314 may similarly include corrective code 326 for mitigating the effects of another known defect in the code of application 302. In this example configuration and example operation thereof, the undesirable effects of a known defect in the code of application 302 are mitigated by corrective code external to application 302. Corrective code 324 can be activated on demand, such as when call 318 provides an indication that the known defect will be executed.

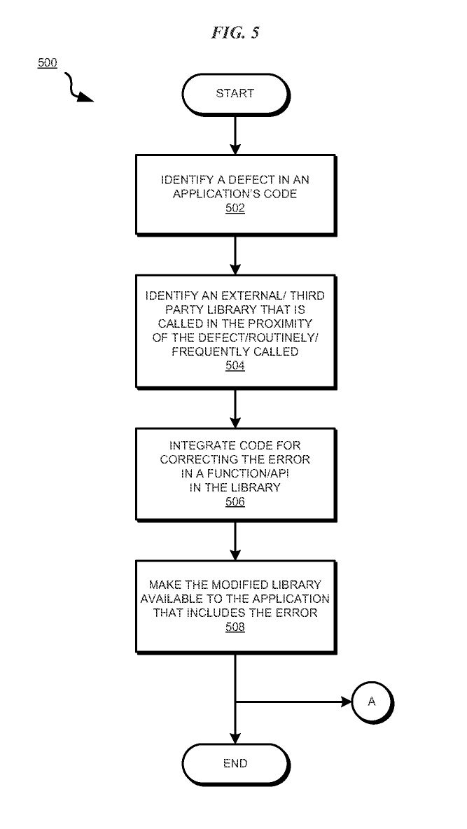

With reference to FIG. 4, this figure depicts an example code of an application in which a known defect has been mitigated without modifying the code, in accordance with an illustrative embodiment. Code 402 may be representative of the code of application 302 in FIG. 3. Code 402 calls certain APIs of an example logger library, some of which have been modified to include suitable corrective code for the defect in code 402.

Code 402 includes the code for a “createUser” function, which accepts a parameter called “username”. When the “createUser” function is called during the application's execution, mitigating log handler 404 is activated by calling the getLogger API. Mitigating log handler 404 further includes modified APIs as described below.

For example, “entry” API of mitigating log handler 404 is called at step 406 with the function name and the value of the parameter the function received. In this manner, some example state information of the application of code 402 is recorded for future use in a corrective action, if needed.

Because line 408 of code 402 sets object “registryService” to “null”, line 410 becomes a defect in code 402 for calling a method of a null object. Accordingly, when executed, code 402 generates exception “e” which is caught by executing the “catch” block of code 402.

Logging instrumentation is common in the exception catching blocks of well written code. Code 402 includes call 412 to “error” API of mitigating log handler 404 with the “e” value of the exception raised. By detecting call 412, mitigating log handler 404 detects that the defect has caused an error for which corrective action will be needed.

In one embodiment, call 412 may include the corrective action. In other words, call to the “error” API may trigger corrective code that may be embedded in the “error” API. In another embodiment, following the error detection in call 412, call 414 to the “exit” API of mitigating log handler 404 may take the corrective action using the state information recorder earlier.

Note that the detection of the error and corrective actions all take place within the context of the application of code 402 having access to the application's state information. Accordingly, the corrective action may be more accurate, relevant, and accommodating of the application's state as different from some prior art that trigger a separate process for the corrective actions. For example, in the prior art, the contents of a log entry by the “error” API may cause a second application, which may be monitoring the logs, to take a corrective action. However, such corrective action in the prior art occurs outside the context of the application of code 402 and therefore have a disadvantage of not having access to code 402's application's state information.

Following are some examples of the corrective actions that can be taken by corrective code external to code 402. For example, the corrective code in mitigating log handler 404 or another suitable library may update, modify, or change a database record that was manipulated incorrectly by the defect in code 402. As another example, the corrective code may clear the data or locks orphaned due to the defect in code 402.

As another example, the corrective code may release memory affected by memory leaks in code 402. As another example, the corrective code may perform garbage collection or release unused resources resulting from the defect in code 402. These examples of the corrective actions, which can be coded in a library that binds with the application containing the defect, are not intended to be limiting on the invention. Many other corrective actions for many other defects will be apparent from this disclosure to those of ordinary skill in the art, and the same are contemplated within the scope of the invention. The corrective actions may be implemented in any suitable form in a library or tool that bind or otherwise dynamically interact with the application, in a similar manner, within the scope of the invention.

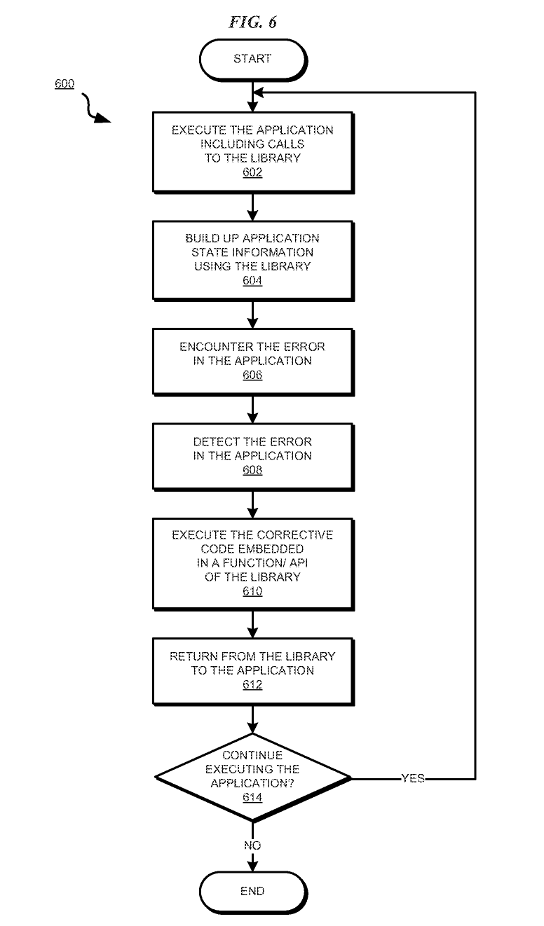

With reference to FIG. 5, this figure depicts a flowchart of an example process of configuring software code for mitigating known software defects in accordance with an illustrative embodiment. Process 500 may be implemented in any software design process, application, or methodology, such as software design tool 109 in FIG. 1.

Process 500 begins by identifying a defect in an application's code (step 502). Process 500 identifies a library, such as an external or a third-party library or toolkit, that is called in the proximity of the defect (step 504). The functions of the library may be called as a matter of good design practices throughout certain sections of the code.

Process 500 integrates the code for correcting the error from the defect in a suitable function or API of the library (step 506). Process 500 makes the modified library available to the application including the defect (step 508). Process 500 ends thereafter.

With reference to FIG. 6, this figure depicts a flowchart of another example process of mitigating known software errors in accordance with an illustrative embodiment. Process 600 may be implemented in an application containing a defect, such as application 302 in FIG. 3, application of code 402 in FIG. 4, or the application of step 508 in FIG. 5.

Process 600 begins by executing the application, including making calls to the library (step 602). Optionally, process 600 may build up or accumulate the state information of the application for future use in any corrective actions (step 604). Process 600 encounters an error during the execution (step 606). Process 600 may optionally detect or identify the error, or gather additional information about the error (step 608).

For that error, process 600 executes the corrective code that is embedded in a function or API of the library by calling that function or API (step 610). Upon executing the corrective code, and mitigating the effects of the defect as much as possible under the given circumstances, process 600 returns from the library call (step 612).

Process 600 determines whether the execution of the application should continue (step 614). If the execution should continue (“yes” path of step 614), process 600 returns to step 602. If the execution should end (“No” path of step 614), process 600 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for mitigating known software defects and their effects. Using an embodiment of the invention, code containing known defects need not be modified prior to release, thereby avoiding costs and risks associated with code modification. An embodiment allows the corrective code to be included in a separate part of the software application containing the defective code, such as in a library or a toolkit accessible to the application. An embodiment further allows the corrective code to be activated on demand, such as upon detection of an error due to the defect.

An embodiment operates within the same process space as of the application including the defective code. Therefore, an embodiment is capable of performing corrective actions that take into account the present state of the application, the state from which to recover, and possibly also the state in which to put the application to continue execution.

Furthermore, when the defect is eventually remedied in the code of the application, such as in a patch release, minor release, or a version update, the corrective code need not be addressed within the remedied code of the application, as the corrective code is external to that code. The library, toolkit, or the function therein, that has been modified with the corrective code, may simply be restored to the original form without requiring additional code testing for the removal of the corrective code.

Certain configurations of the defective application and the library including the corrective code are described in the various embodiments only as examples and are not intended to be limiting on the invention. Many other manner of deploying the defective application and the library with the corrective code, and for enabling the interaction between them will be apparent to those of ordinary skill in the art and the same are contemplated within the scope of the invention. For example, in one possible scenario, the software packaging activity may have already been performed by a software vendor and the software package including the defective application may already be deployed at a customer site. The API library in which the corrective code is provided may be a part of the runtime environment that is made available to the defective application.

Any suitable method for allowing late binding of an API library into an application may be used to allow the defective application to access the library containing the corrective code. For example, a library might be enabled by—environment variables within an operating system such as CLASSPATH or LIBRARY_PATH, that the defective application may use to access the library containing the corrective code. As another example, configuration settings in an enterprise application server that hosts the defective application, variables in a “shell script” or “batch script” that launches the defective application may be used for linking the API library into the application's classloader by using various extension points provided by the Java virtual machine (JVM). Thus, the API library including the corrective code can be enabled/deployed to interact or dynamically associate with a defective application in a very flexible way, i.e., without requiring repackaging the software or other steps normally performed by the vendor in the software release process.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for mitigating a known software defect, the method comprising:
executing a code containing the defect in a data processing system;
detecting an error caused by the defect;
calling a function implemented external to the code, wherein the function is a part of a library accessible to the code, and wherein the function is called for the code for a purpose other than to correct the error;
executing a corrective code embedded in the function, the corrective code attempting to correct the error; and
continuing executing the code after the corrective code has corrected the error.

2. The computer implemented method of claim 1, wherein a previous call to the library saves a state information, wherein the state information is one of (i) a present state of code execution before the error occurs, (ii) the state of the code execution from which to recover, and (iii) the state in which to place the code for continued execution.

3. The computer implemented method of claim 1, wherein the corrective code uses a state information of the code execution in attempting to correct the error.

4. The computer implemented method of claim 1, wherein the defect is identified in the code before the code is deployed on a data processing system, wherein the code already includes a call to the function in the library, wherein the call to the function is at a point in the code where the error caused by the defect can be corrected, and wherein the library is to be deployed together with the code.

5. The computer implemented method of claim 1, further comprising:
activating the execution of the corrective code on demand when the error in encountered.

6. The computer implemented method of claim 1, wherein the library includes a set of application programming interfaces (APIs) for making log entries during the execution of the code.

7. The computer implemented method of claim 6, wherein the execution of the corrective code is activated by changing a logging parameter while executing the code.

8. The computer implemented method of claim 1, wherein the code is deployed on the data processing system at a first time, the library is deployed on the data processing system at a second time, and wherein the library is deployed in such a manner that the code deployed a the first time can dynamically associate with the library deployed at the second time.

9. A computer usable program product comprising a computer usable storage medium including computer usable code for mitigating a known software defect, the computer usable code comprising:
computer usable code for executing a code containing the defect in a data processing system;
computer usable code for detecting an error caused by the defect;
computer usable code for calling a function implemented external to the code, wherein the function is a part of a library accessible to the code, and wherein the function is called for the code for a purpose other than to correct the error;
computer usable code for executing a corrective code embedded in the function, the corrective code attempting to correct the error; and
computer usable code for continuing executing the code after the corrective code has corrected the error.

10. The computer usable program product of claim 9, wherein a previous call to the library saves a state information, wherein the state information is one of (i) a present state of code execution before the error occurs, (ii) the state of the code execution from which to recover, and (iii) the state in which to place the code for continued execution.

11. The computer usable program product of claim 1, wherein the corrective code uses a state information of the code execution in attempting to correct the error.

12. The computer usable program product of claim 9, wherein the defect is identified in the code before the code is deployed on a data processing system, wherein the code already includes a call to the function in the library, wherein the call to the function is at a point in the code where the error caused by the defect can be corrected, and wherein the library is to be deployed together with the code.

13. The computer usable program product of claim 9, further comprising:
computer usable code for activating the execution of the corrective code on demand when the error in encountered.

14. The computer usable program product of claim 9, wherein the library includes a set of application programming interfaces (APIs) for making log entries during the execution of the code.

15. The computer usable program product of claim 14, wherein the execution of the corrective code is activated by changing a logging parameter while executing the code.

16. The computer usable program product of claim 9, wherein the code is deployed on the data processing system at a first time, the library is deployed on the data processing system at a second time, and wherein the library is deployed in such a manner that the code deployed a the first time can dynamically associate with the library deployed at the second time.

17. The computer usable program product of claim 9, wherein the computer usable code is stored in a computer readable storage medium in a data processing system, and wherein the computer usable code is transferred over a network from a remote data processing system.

18. The computer usable program product of claim 9, wherein the computer usable code is stored in a computer readable storage medium in a server data processing system, and wherein the computer usable code is downloaded over a network to a remote data processing system for use in a computer readable storage medium associated with the remote data processing system.

19. A data processing system for mitigating a known software defect, the data processing system comprising:
a storage device including a storage medium, wherein the storage device stores computer usable program code; and
a processor, wherein the processor executes the computer usable program code, and wherein the computer usable program code comprises:
computer usable code for executing a code containing the defect in a data processing system;
computer usable code for detecting an error caused by the defect;
computer usable code for calling a function implemented external to the code, wherein the function is a part of a library accessible to the code, and wherein the function is called for the code for a purpose other than to correct the error;
computer usable code for executing a corrective code embedded in the function, the corrective code attempting to correct the error; and
computer usable code for continuing executing the code after the corrective code has corrected the error.

20. The data processing system of claim 19, wherein a previous call to the library saves a state information, wherein the state information is one of (i) a present state of code execution before the error occurs, (ii) the state of the code execution from which to recover, and (iii) the state in which to place the code for continued execution.
